(19) United States
(12) Patent Application Publication
(10) Pub. No.: US 2025/0236970 A1
(43) Pub. Date: Jul. 24, 2025

(54) METHOD OF COATING ELECTRODE INK

(71) Applicant: HONDA MOTOR CO., LTD., Tokyo (JP)

(72) Inventors: Wataru KASHI, Saitama (JP); Yohei KATAOKA, Saitama (JP); Kento KUSATSUGU, Saitama (JP); Shinsuke CHOKYU, Saitama (JP)

(21) Appl. No.: 19/017,786

(22) Filed: Jan. 13, 2025

(30) Foreign Application Priority Data
Jan. 18, 2024 (JP) 2024-006312

(51) Int. Cl. C25B 11/032; C25B 9/23; C25B 13/08

(52) U.S. Cl. CPC C25B 11/032; C25B 9/23; C25B 13/08

(57) ABSTRACT

A method of coating an electrode ink that can form an electrode layer easily is provided. The method of coating an electrode ink for forming an electrode layer on a porous gas diffusion layer includes a heating step of heating a lower surface of the gas diffusion layer by a heating means; a coating step of coating an electrode ink on the gas diffusion layer; a drying step of drying the electrode ink coated in the coating step; and a repeating step of repeatedly performing the coating step and the drying step. It is preferable that the repeating step is performed until a surface of the gas diffusion layer is covered with the electrode ink.

This application is based on and claims the benefit of priority from Japanese Patent Application No. 2024-006312, filed on 18 Jan. 2024, the content of which is incorporated herein by reference.

### BACKGROUND OF THE INVENTION

### Field of the Invention

The present invention relates to a method of coating an electrode ink.

### Related Art

Conventionally, it has been known that a catalyst layer-coated electrolyte membrane (CCM) in which an anode electrode layer and a cathode electrode layer are disposed and bonded to both sides of a solid polymer electrolyte membrane is used for water electrolysis and the like. A technique has been proposed in which, upon producing such a catalyst layer-coated electrolyte membrane, an electrode ink constituting an electrode layer is applied to a base material constituting a solid polymer electrolyte membrane, and then dried (see, for example, Japanese Patent No. 4993915).
Patent Document 1: Japanese Patent No. 4993915

### SUMMARY OF THE INVENTION

When a catalyst layer-coated electrolyte membrane in which an electrode layer is bonded to a solid polymer electrolyte membrane is used for water electrolysis, the electrode layer may peel off during electrolysis. Therefore, it is conceivable to form an electrode layer on a diffusion layer of a gas diffusion electrode (GDE) disposed outside the solid polymer electrolyte membrane. However, when the electrode layer is applied to the diffusion layer, since the diffusion layer is constituted by a porous body, there has been a problem in that the electrode ink penetrates deeply, which makes it difficult to form the electrode layer.
(1) The present invention is directed to a method of coating an electrode ink (for example, an electrode ink 20) for forming an electrode layer (for example, an electrode layer 2) on a porous gas diffusion layer (for example, a gas diffusion layer 4), the method including: a heating step (for example, a heating step S1) of heating a lower surface of the gas diffusion layer by a heater (for example, a heating means 5); a coating step (for example, a coating step S2) of coating the electrode ink on the gas diffusion layer; a drying step (for example, a drying step S3) of drying the electrode ink coated in the coating step; and a repeating step (for example, a repeating step S4) of repeatedly performing the coating step and the drying step.
(2) It is preferable that the repeating step is performed until a surface of the gas diffusion layer is covered with the electrode ink.
(3) It is preferable that the heating step is performed by placing the gas diffusion layer on the heater which is plate-shaped and capable of raising temperature.
(4) The present invention is directed to an electrolyte membrane and electrode assembly including: a solid polymer electrolyte membrane (for example, a solid polymer electrolyte membrane 3); electrode layers (for example, electrode layers 2) on both sides of the solid polymer electrolyte membrane; and gas diffusion electrodes (for example, gas diffusion electrodes 10) each including a gas diffusion layer (for example, a gas diffusion layer 4) provided on an outer side of a corresponding one of the electrode layers, in which the gas diffusion layer includes a porous sheet-shaped member (for example, a sheet-shaped member 40), and the electrode layers include an electrode inner layer (for example, an electrode inner layer 2a) in which an electrode ink (for example, an electrode ink 20) penetrates into the gas diffusion layer and is dried, and an electrode outer layer (for example, an electrode outer layer 2b) in which the electrode ink is provided on a surface of the gas diffusion layer.

According to the above (1), since the electrode ink is coated in a state where the gas diffusion layer is heated from the lower surface, the electrode ink dries before reaching the lower surface of the gas diffusion layer, and remains inside the gas diffusion layer. By repeating coating and drying from this state, it is possible to quickly coat the electrode ink on the surface of the gas diffusion layer. In addition, since a part of the electrode layer is integrally bonded to the gas diffusion layer inside the gas diffusion layer, when the water electrolysis is performed, a part of the electrode layer integrated with the gas diffusion layer in the aqueous solution exhibits an anchor effect, and peeling of the electrode layer 2 is suppressed.

According to the above (2), by repeating the coating step and the drying step until the surface of the gas diffusion layer reaches a state covered with the electrode ink, it is possible to reliably bond the electrode layer to the gas diffusion layer so as to be difficult to peel off from the gas diffusion layer, such that it is possible to coat the electrode layer on the gas diffusion layer.

According to the above (3), by placing the gas diffusion layer on the heating means which is plate-shaped and capable of raising the temperature, and heating the gas diffusion layer, it is possible to dry the gas diffusion layer simultaneously while coating, such that the efficiency of the manufacturing process is improved.

According to the above (4), since the electrode inner layer is integrally bonded to the gas diffusion layer inside the gas diffusion layer, when the water electrolysis is performed, a part of the electrode layer integrated with the gas diffusion layer in the aqueous solution exhibits an anchor effect, and peeling of the electrode layer is suppressed.

### BRIEF DESCRIPTION OF THE DRAWINGS

FIG. 1 is a diagram illustrating a structure of an electrolyte membrane and electrode assembly of the present embodiment;

FIG. 2A is a diagram illustrating an initial stage of a coating step and a heating step of the present embodiment;

FIG. 2B is a diagram illustrating a state in the middle of a repeating step of the present embodiment;

FIG. 2C is a diagram illustrating a state in the middle of the repeating step of the present embodiment; and

FIG. 2D is a diagram illustrating a state in which the coating step of the present embodiment is completed.

### DETAILED DESCRIPTION OF THE INVENTION

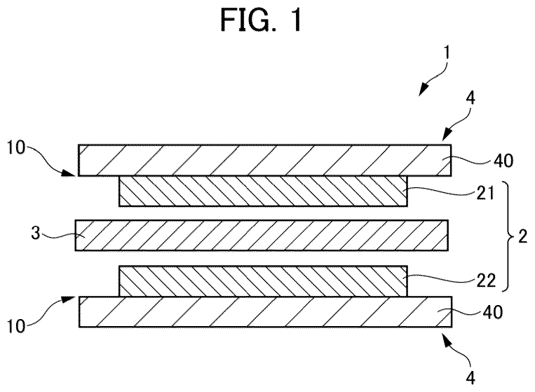

Hereinafter, an embodiment of the present disclosure will be described in detail with reference to the drawings. As shown in FIG. 1, the coating method of the electrode ink of the present embodiment is used in the manufacture of an electrolyte membrane and electrode assembly (MEA) 1 having a gas diffusion electrode (GDE) 10. In the electrolyte membrane and electrode assembly 1 of the present embodiment, electrode layers 2 are provided on both surfaces of a solid polymer electrolyte membrane 3, gas diffusion layers 4 are provided respectively on the outer sides of the electrode layers 2, and the electrode layers 2 are provided respectively on the gas diffusion layers (GDL) 4, thereby providing a gas diffusion electrode 10.

The gas diffusion layers 4 each include a porous sheet-shaped member 40. The sheet-shaped member 40 may be, for example, nickel foam or carbon cloth.

The electrode layer 2 is a catalyst layer including an anode electrode layer 21 and a cathode electrode layer 22. The electrode layer 2 is formed by applying the electrode ink 20 to the gas diffusion layer 4. The electrode ink 20 is a liquid containing a composition for forming an electrode, and may be, for example, a liquid containing a catalyst support supporting a catalyst, an ionomer (electrolytic polymer, electrolyte solution) having proton conductivity, and a dispersion solvent for dispersing the catalyst support and the ionomer. The dispersion solvent may be water. The viscosity of the electrode ink 20 may be, for example, about 1 to 10 mPas.

The solid polymer electrolyte membrane 3 is, for example, a proton conductive membrane in which a polymer having proton conductivity belonging to a cation exchange resin is formed in a film shape. Examples of the cation exchange resin include a sulfonated product of a vinyl polymer such as polystyrene sulfonic acid, a perfluoroalkyl sulfonic acid polymer, a perfluoroalkyl carboxylic acid polymer, a polymer obtained by introducing a sulfonic acid group or a phosphoric acid group into a heat-resistant polymer such as polybenzimidazole or polyether ether ketone, and a polymer having, as a main component, a rigid polyphenylene obtained by polymerizing an aromatic compound having a phenylene chain and introducing a sulfonic acid group thereto.

In the coating method of the electrode ink according to the present embodiment, a coating device (not shown) and a plate-shaped heating means 5 called a surface plate are used. The coating device used is not particularly limited, but the electrode ink 20 is coated while moving a blade, a bar coater, or other known applicators in a certain direction and, for example, a blade coater may be used.

The heating means 5 has a thin substantially rectangular parallelepiped plate-shaped member having a flat surface, and a heater (not shown) is provided on the plate-shaped member. The surface of the heating means 5 is heated by the heater to raise the temperature. As a result, the temperature of the sheet-shaped member 40 placed on the heating means 5 is raised. The heating means 5 may be a metal plate-shaped member on which an electric heating device is disposed. The heater may be disposed inside the plate-like member or may be attached to the outside.

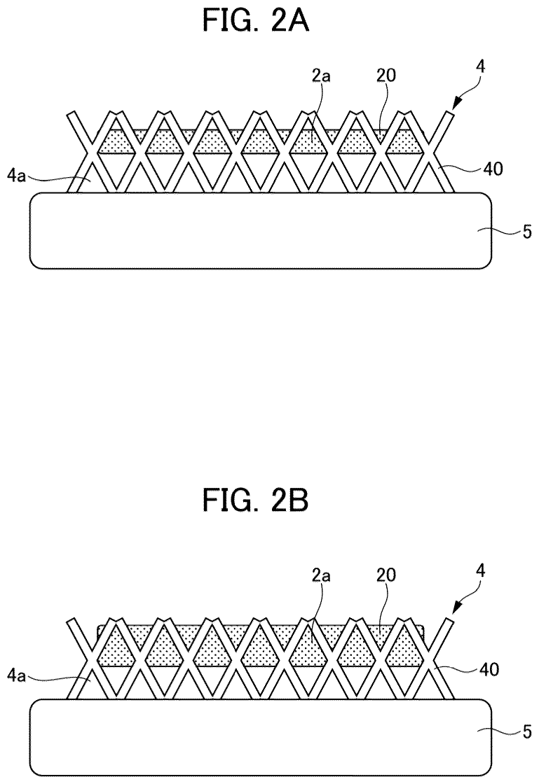

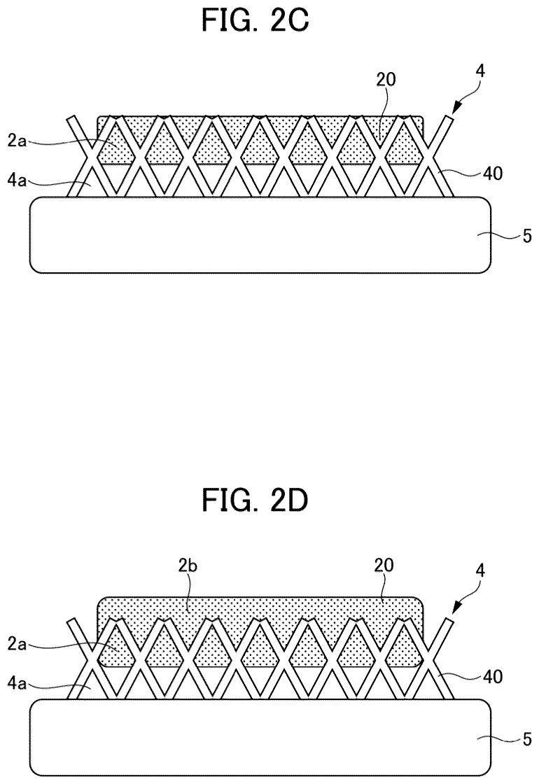

As shown in FIG. 2A, the sheet-shaped member 40 is placed on the heating means 5, and the lower surface of the sheet-shaped member 40 is heated by a heater (heating step S1). The heating temperature is preferably in the range of 80° C. to 100° C. in consideration of the temperature at which the electrode ink 20 to be coated can be dried and the temperature at which the solvent contained in the electrode ink 20 is volatilized.

While heating is performed in the heating step S1, the electrode ink 20 is coated on the sheet-shaped member 40 in parallel using a blade coater (coating step S2). In the state shown in FIG. 2A, the electrode ink 20 penetrates into the inside of the sheet-shaped member 40. However, since the sheet-shaped member 40 is heated, the electrode ink 20 does not reach the lower surface of the sheet-shaped member 40, and stays slightly above the lower surface of the sheet-shaped member 40 in the thickness direction while partially drying.

In the state of FIG. 2A, the electrode ink 20 coated in the coating step S2 is dried (drying step S3). In the drying step S3, after the electrode ink 20 is coated on the sheet-shaped member 40 by a blade coater, the coated sheet-shaped member is placed on the heating means 5 for a predetermined time, for example, about 50 seconds to 70 seconds. In the meantime, the coated electrode ink 20 is dried by the heat of the heating means 5.

As shown in FIG. 2A, the electrode ink 20 penetrates into the sheet-shaped member 40 only once coated. However, since the sheet-shaped member 40 is heated to 80 degrees or more by the heating means 5, the electrode ink 20 does not reach the lower surface of the sheet-shaped member 40, and remains inside the sheet-shaped member 40.

As shown in FIGS. 2B to 2D, the coating step S2 and the drying step S3 are repeatedly performed (repeating step S4). The number of repetitions is not particularly limited as long as the repeating step S4 can be performed until the surface of the sheet-shaped member 40 reaches a state covered with the electrode ink 20. For example, it is preferable to repeat the coating step S2 and the drying step S3 about eight times. As shown in FIG. 2B and FIG. 2C, when the coating step S2 and the drying step S3 are repeatedly performed, the electrode ink 20 overlaps and becomes thicker every time the coating is performed, and is finally disposed so as to cover the surface of the sheet-shaped member 40 as shown in FIG. 2D. By repeating the coating step S2 and the drying step S3, the electrode ink 20 is coated on the sheet-shaped member 40 to form the electrode layer 2. The thickness of the electrode layer 2 may be, for example, several tens of microns.

In FIGS. 2B to 2D, among the electrode layers 2 formed by applying the electrode ink 20, a layer in which the electrode ink 20 penetrates into the sheet-shaped member 40 and remains in a dried state is an electrode inner layer 2a, and a layer in which the electrode ink 20 is exposed to be disposed on the surface of the sheet-shaped member 40 is an electrode outer layer 2b. In addition, by the lowermost side of the electrode layer 2 not reaching the sheet-shaped member 40 by the heating means 5, a void layer 4a in which only the porous layer of the sheet-shaped member 40 is disposed is also formed between the lower surface of the electrode inner layer 2a and the lower surface of the sheet-shaped member 40.

The coating method including the heating step S1, the drying step S3, and the repeating step S4 described above is used upon forming each of the anode electrode layer 21 and the cathode electrode layer 22. In FIG. 1, for convenience of explanation, the anode electrode layer 21, the cathode electrode layer 22, and the solid polymer electrolyte membrane 3 are shown spaced apart from one another. Actually, the anode electrode layer 21 and the cathode electrode layer 22 formed in the above steps are disposed in a state of being in contact with one and the other of the solid polymer electrolyte membrane 3, but not being bonded thereto.

According to the present embodiment, the following advantageous effects are achieved.
(1) A method of coating an electrode ink for forming the electrode layer 2 on the porous gas diffusion layer 4 is provided which includes the heating step S1 of heating a lower surface of the gas diffusion layer 4 by the heating means 5; the coating step S2 of coating the electrode ink 20 on the gas diffusion layer 4; the drying step S3 of drying the electrode ink 20 coated in the coating step S2; and the repeating step S4 of repeatedly performing the coating step S2 and the drying step S3. Since the electrode ink 20 is coated in a state where the gas diffusion layer 4 is heated from the lower surface, the electrode ink 20 dries before reaching the lower surface of the gas diffusion layer 4 and remains inside the gas diffusion layer 4. By repeating the coating and drying from this state, the electrode ink 20 can be quickly coated on the surface of the gas diffusion layer 4. In addition, since a part of the electrode layer 2 is integrally bonded to the gas diffusion layer 4 inside the gas diffusion layer 4, when the water electrolysis is performed, a part of the electrode layer 2 integrated with the gas diffusion layer 4 exhibits an anchor effect in the aqueous solution, and peeling of the electrode layer 2 is suppressed.
(2) According to the present embodiment, the repeating step S4 is performed until a surface of the gas diffusion layer 4 enters a state covered with the electrode ink 20. By repeating the coating step S2 and the drying step S3 until the surface of the gas diffusion layer 4 enters a state covered with the electrode ink 20, the electrode layer 2 can be reliably bonded to the gas diffusion layer 4 so as not to be easily peeled off from the gas diffusion layer 4, and the electrode layer 2 can be coated on the gas diffusion layer 4.
(3) According to the present embodiment, the heating step S1 is performed by placing the gas diffusion layer 4 on the heating means 5 which is plate-shaped and capable of raising temperature. By placing the gas diffusion layer 4 on the heating means 5 which is plate-shaped and capable of raising temperature, and heating the gas diffusion layer 4, it is possible to dry the gas diffusion layer 4 at the same time while coating, and the efficiency of the manufacturing process is improved.
(4) According to the present embodiment, the electrolyte membrane and electrode assembly 1 includes: the solid polymer electrolyte membrane 3; the electrode layers 2 on both sides of the solid polymer electrolyte membrane 3; and the gas diffusion electrodes 10 each including the gas diffusion layer 4 provided on an outer side of a corresponding one of the electrode layers 2. The gas diffusion layer 4 includes the porous sheet-shaped member 40. The electrode layers 2 include the electrode inner layer 2a in which the electrode ink 20 penetrates into the gas diffusion layer 4 and is dried, and the electrode outer layer 2b in which the electrode ink 20 is provided on a surface of the gas diffusion layer 4. Since the electrode inner layer 2a is integrally bonded to the gas diffusion layer 4 inside the gas diffusion layer 4, when the water electrolysis is performed, a part of the electrode layer 2 integrated with the gas diffusion layer 4 exhibits an anchor effect in the aqueous solution, and peeling of the electrode layer 2 is suppressed.

The present invention is not limited to the above-described embodiment, and modifications, improvements, and the like within a range in which the object of the present invention can be achieved are included in the present invention. The number of times of coating, the drying temperature, the viscosity of the electrode ink 20, and the like correlate with each other, and may be appropriately changed as necessary.

### EXPLANATION OF REFERENCE NUMERALS

1 Electrolyte membrane and electrode assembly
2 Electrode layer
3 Solid polymer electrolyte membrane
4 Gas diffusion layer
4a Electrode inner layer
4b Electrode outer layer
5 Heating means
10 Gas diffusion electrode
20 Electrode ink
40 Sheet-shaped member

What is claimed is:

1. A method of coating an electrode ink for forming an electrode layer on a porous gas diffusion layer, the method comprising:
a heating step of heating a lower surface of the gas diffusion layer by a heater;
a coating step of coating the electrode ink on the gas diffusion layer;
a drying step of drying the electrode ink coated in the coating step; and
a repeating step of repeatedly performing the coating step and the drying step.

2. The method of coating an electrode ink according to claim 1, wherein the repeating step is performed until a surface of the gas diffusion layer is covered with the electrode ink.

3. The method of coating an electrode ink according to claim 1, wherein the heating step is performed by placing the gas diffusion layer on the heater which is plate-shaped and capable of raising temperature.

4. The method of coating an electrode ink according to claim 2, wherein the heating step is performed by placing the gas diffusion layer on the heater which is plate-shaped and capable of raising temperature.

5. An electrolyte membrane and electrode assembly comprising:
a solid polymer electrolyte membrane;
electrode layers on both sides of the solid polymer electrolyte membrane; and
gas diffusion electrodes each including a gas diffusion layer provided on an outer side of a corresponding one of the electrode layers,
wherein the gas diffusion layer includes a porous sheet-shaped member, and
the electrode layers include an electrode inner layer in which an electrode ink penetrates into the gas diffusion layer and is dried, and an electrode outer layer in which the electrode ink is provided on a surface of the gas diffusion layer.
